(19) United States
(12) Patent Application Publication
(10) Pub. No.: US 2005/0065919 A1
(43) Pub. Date: Mar. 24, 2005

(54) Method and apparatus for document filtering capable of efficiently extracting document matching to searcher's intention using learning data

(76) Inventors: Atsushi Gotoh, Tokyo (JP); Hideo Itoh, Tokyo (JP)

Correspondence Address: DICKSTEIN SHAPIRO MORIN & OSHINSKY LLP, 2101 L Street, NW, Washington, DC, 20037, US

(21) Appl. No.: 10/941,835

(22) Filed: Sep. 16, 2004

(30) Foreign Application Priority Data
Sep. 19, 2003 (JP) 2003-329206

(51) Int. Cl. G06F 17/30

(52) U.S. Cl. 707/3

(57) ABSTRACT

A document filtering apparatus includes an information input/output unit, a search word extraction unit, a first ranking search unit, a learning data unit, a classifying parameter generation unit, a second ranking search unit, and a classifying unit. The information input/output unit inputs phrasal information, and outputs search result information. The search word extraction unit extracts a search word from the phrasal information. The first ranking search unit searches a document having the search word from a database, and outputs a first ranking search result. The learning data unit prepares learning data from the first ranking search result. The classifying parameter generation unit generates a classifying parameter from the learning data. The second ranking search unit searches a document having a word corresponding to the classifying parameter from the database. The classifying unit extracts a document matching to a searcher's intention, and outputs the document as a second ranking search result.

This patent application claims priority from Japanese patent application No. 2003-329206 filed on Sep. 19, 2003 in the Japan Patent Office, the entire contents of which are hereby incorporated by reference herein.

### FIELD OF THE INVENTION

The present invention relates to a method and apparatus for document filtering, and more particularly to a method and apparatus for document filtering capable of efficiently extracting documents matching to a searcher's intention using learning data from a document database.

### BACKGROUND OF THE INVENTION

How efficiently searching a document matching to a searcher's intention from a database has been an issue. To cope with the above-mentioned issue, a conventional document searching technique performs a search using a combination of key word and logical operator to obtain a search result, and refines the search result by a subsequent search using a new combination of key word and logical operator.

However, a searcher needs knowledge of a specific expertise to designate an appropriate key word or a combination of key word and logical operator, and needs time to find out such key word. Furthermore, the searcher can determine whether search conditions are appropriate only after the searcher reviews the search result. In addition, a conventional document searching technique obtains an insufficient search result, in which the number of documents matching to a searcher's intention may often be smaller than that of documents not matching to the searcher's intention.

A conventional technique uses a following method to solve the above-mentioned drawback. For example, information includes a plurality of key words (i.e., learning data). Based on such key words and a score dictionary, the input information is converted to a vector for calculating a score using a positive metric and a negative metric for key word codes. Based on the calculated score and a determination parameter, necessity and reliability of the information is learned (i.e., calculated). Based on the values of learned necessity and reliability, unknown data (i.e., document) is evaluated, and the data is sorted in the order of necessity and is presented to the searcher.

Another conventional technique uses a following method to solve the above-mentioned drawback. For example, input information includes a plurality of key words. Such key words are converted to vectors by a vector generator to generate metrics matching to a searcher's intention, and the metrics are divided furthermore. Using the above-mentioned vector and the divided metric, the searcher's intention is calculated into score values, and information in the order of the score values is presented to the searcher.

However, the search result obtained by the above-mentioned conventional techniques may include document data not necessary for the searcher, and have a drawback that they cannot clearly distinguish necessary data and non-necessary data for the searcher from unknown document.

### SUMMARY OF THE INVENTION

The present invention provides a method and apparatus for document filtering capable of efficiently extracting documents matching to a searcher's intention using learning data from a document database.

In one exemplary embodiment, a document filtering apparatus includes an information input/output unit, a search word extraction unit, a first ranking search unit, a learning data unit, a classifying parameter generation unit, a second ranking search unit, and a classifying unit. The information input/output unit inputs phrasal information, and outputs search result information. The search word extraction unit extracts a search word from the phrasal information. The first ranking search unit performs a first ranking search to search a document having the search word from a database, and outputs the document as a first ranking search result. The learning data generation unit prepares learning data reflecting a searcher's intention based on the first ranking search result. The classifying parameter generation unit generates a classifying parameter from the learning data prepared by the learning data generation unit. The second ranking search unit performs a second ranking search to search a document having a word corresponding to the classifying parameter from the database. The classifying unit extracts a document matching to the searcher's intention, and outputs the document as a second ranking search result.

In the above-mentioned document filtering apparatus, the learning data generation unit prepares the learning data using at least a part of the first ranking search result.

In the above-mentioned document filtering apparatus, the classifying parameter generation unit generates the classifying parameter using a predetermined algorism.

In the above-mentioned document filtering apparatus, the predetermined algorism includes at least one of a linear support vector machine, a Fisher discriminant, and a binary independence model of Bayes.

In the above-mentioned document filtering apparatus, the classifying unit evaluates documents obtained by the second ranking search, designates the documents as a matched document when a predetermined condition is satisfied and as an unmatched document when a predetermined condition is not satisfied, extracts the matched document, and transmits the matched document to the information input/output unit.

In the above-mentioned document filtering apparatus, the predetermined condition is calculated using the classifying parameter.

In the above-mentioned document filtering apparatus, the classifying unit sorts the second ranking search result with a predetermined criterion.

In the above-mentioned document filtering apparatus, the predetermined criterion includes a score calculation using the classifying parameter.

In one exemplary embodiment, a novel method of document filtering includes the steps of inputting, extracting, searching, preparing, generating, finding, picking-up, outputting, and displaying. The inputting step input phrasal information. The extracting step extracts a search word from the phrasal information. The searching step searches a document having the search word from a database, and outputs the document as a first ranking search result. The preparing step prepares learning data reflecting a searcher's intention based on the first ranking search result. The generating step generates a classifying parameter from the learning data prepared by the preparing step. The finding step finds a document having a word corresponding to the classifying parameter from the database. The picking-up step picks up a document matching to the searcher's intention. The outputting step outputs the document as a second ranking search result. The displaying step displays the second ranking search result.

In the above-mentioned method of document filtering, the preparing step prepares the learning data using at least a part of the first ranking search result.

In the above-mentioned method of document filtering, the generating step generates the classifying parameter using a predetermined algorism.

In the above-mentioned method of document filtering, the predetermined algorism includes at least one of a linear support vector machine, a Fisher discriminant, and a binary independence model of Bayes.

In the above-mentioned method of document filtering, the classifying step evaluates documents obtained by the second ranking search, designates the documents as a matched document when a predetermined condition is satisfied and as an unmatched document when a predetermined condition is not satisfied, extracts the matched document, and transmits the matched document to the displaying step.

In the above-mentioned method of document filtering, the predetermined condition is calculated using the classifying parameter.

In the above-mentioned method of document filtering, the classifying step sorts the second ranking search result with a predetermined criterion.

In the above-mentioned method of document filtering, the predetermined criterion includes a score calculation using the classifying parameter.

In one exemplary embodiment, a novel program product for document filtering causes a computer to perform a method of document filtering. The method of document filtering includes the steps of inputting, extracting, searching, preparing, generating, finding, picking-up, outputting, and displaying. The inputting step input phrasal information. The extracting step extracts a search word from the phrasal information. The searching step searches a document having the search word from a database, and outputs the document as a first ranking search result. The preparing step prepares learning data reflecting a searcher's intention based on the first ranking search result. The generating step generates a classifying parameter from the learning data prepared by the preparing step. The finding step finds a document having a word corresponding to the classifying parameter from the database. The picking-up step picks up a document matching to the searcher's intention. The outputting step outputs the document as a second ranking search result. The displaying step displays the second ranking search result.

In one exemplary embodiment, a novel computer readable medium stores a program product for document filtering causes a computer to perform a method of document filtering. The method of document filtering includes the steps of inputting, extracting, searching, preparing, generating, finding, picking-up, outputting, and displaying. The inputting step input phrasal information. The extracting step extracts a search word from the phrasal information. The searching step searches a document having the search word from a database, and outputs the document as a first ranking search result. The preparing step prepares learning data reflecting a searcher's intention based on the first ranking search result. The generating step generates a classifying parameter from the learning data prepared by the preparing step. The finding step finds a document having a word corresponding to the classifying parameter from the database. The picking-up step picks up a document matching to the searcher's intention. The outputting step outputs the document as a second ranking search result. The displaying step displays the second ranking search result.

### BRIEF DESCRIPTION OF THE DRAWINGS

A more complete appreciation of the disclosure and many of the attendant advantages thereof can readily be obtained and understood from the following detailed description with reference to the accompanying drawings wherein:

FIG. 1 is an exemplary block diagram of a document filtering apparatus according to an exemplary embodiment of the present invention;

FIGS. 2A and 2B show a flow chart explaining steps of performing a method of document filtering according to an exemplary embodiment of the present invention;

FIG. 3 is an exemplary display view displaying a search phrase input by a searcher;

FIG. 4 is an exemplary display view displaying a first ranking search result; and

FIG. 5 is an exemplary display view displaying a second ranking search result.

### DETAILED DESCRIPTION OF THE EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

In the drawings, like reference numerals designate identical or corresponding parts throughout the several views.

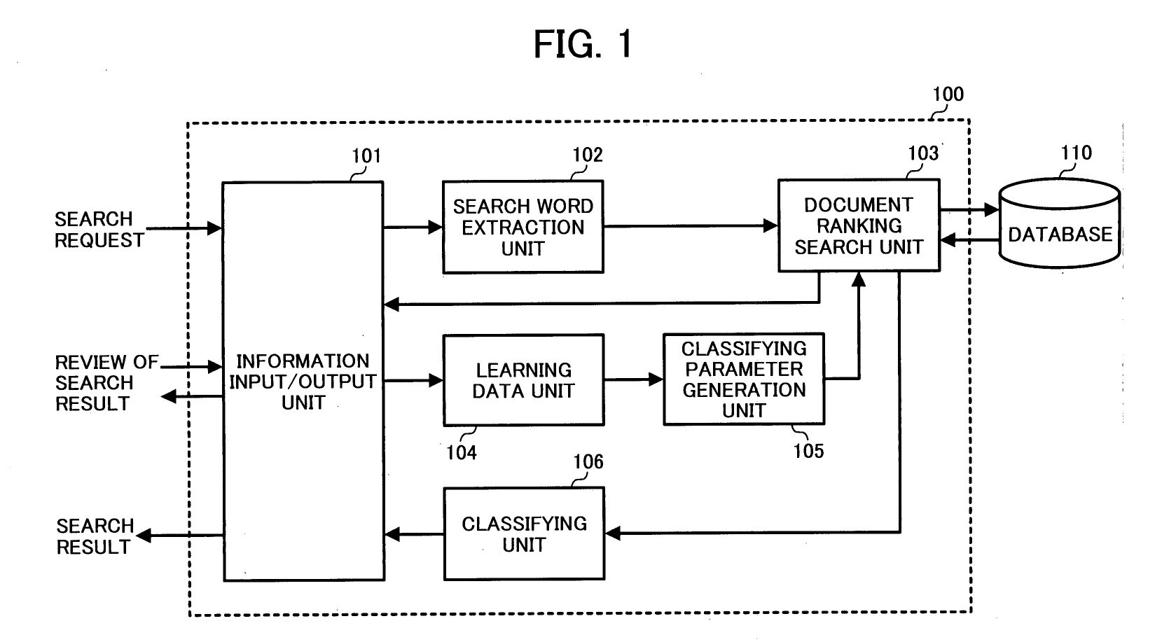

FIG. 1 is an exemplary block diagram of a document filtering apparatus according to an exemplary embodiment of the present invention.

A document filtering apparatus 100 includes an information input/output unit 101, a search word extraction unit 102, a document ranking search unit 103, a learning data generation unit 104, a classifying parameter generation unit 105, and a classifying unit 106. Furthermore, the document filtering apparatus 100 is connected to a database 110.

A searcher input a search phrase to the information input/output unit 101. The search phrase includes at least one of a sentence or a word.

The information input/output unit 101 transmits the search phrase to the search word extraction unit 102.

The search word extraction unit 102 extracts a search word from the search phrase, and transmits the search word to the document ranking search unit 103. The search word extraction unit 102 extracts a search word using a method described in United States Patent Application Publication 2004/0111404 A1, the entire contents of which are incorporated herein by reference.

The document ranking search unit 103 performs a first ranking search to search a document having the search word from the database 110, and obtain a first ranking search result. In the ranking search, searched documents are ranked according to relevance to a searcher's intention of each of the documents. The ranking search includes the first ranking search, and a second ranking search to be described later.

The document ranking search unit 103 transmits the first ranking search result to the information input/output unit 101.

The information input/output unit 101 displays the first ranking search result on a display unit (not shown).

The searcher reviews contents of the first ranking search result displayed on the display unit (not shown), and designates documents included in the first ranking search result as a matched document when a document matches to a searcher's intention and an unmatched document when a document does not match to a searcher's intention via the information input/output unit 101.

Based on such designated information, the learning data generation unit 104 prepares learning data that classify a document matching to the searcher's intention as matched document and a document not matching to the searcher's intention as unmatched document.

Based on the learning data, the classifying parameter generation unit 105 generates a classifying parameter (to be described in detail later).

By using a word corresponding to the classifying parameter as a search word, the document ranking search unit 103 performs a second ranking search to search a document having such search word from the database 110.

The classifying unit 106 evaluates each document obtained by the second ranking search to extract only matched documents, and transmits the matched documents as a second ranking search result to the information input/output unit 101. A document filtering operation performed with the learning data generation unit 104, the classifying parameter generation unit 105, and the classifying unit 106 will be described in detail later.

The information input/output unit 101 displays the matched documents received from the classifying unit 106 on the display unit (not shown).

Hereinafter, an exemplary method of document filtering using the document filtering apparatus of the present invention will be described in detail.

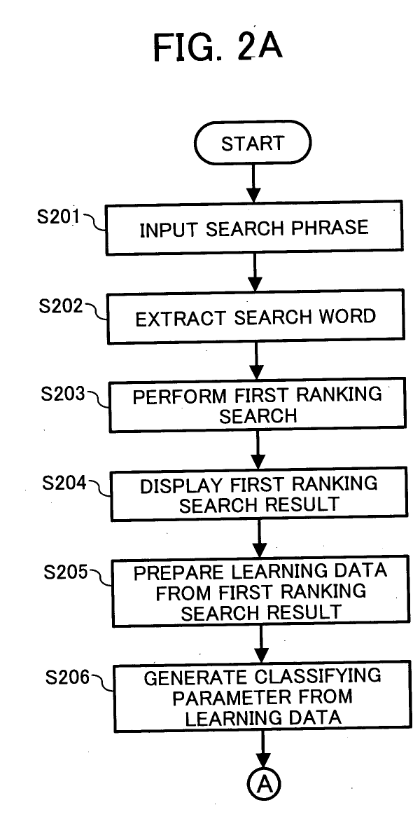

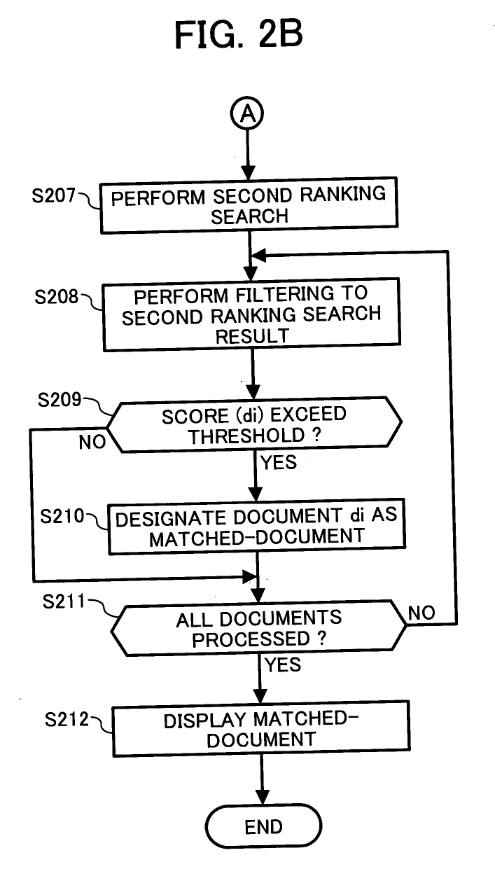

FIGS. 2A and 2B show a flow chart explaining steps for an exemplary method of document filtering.

In Step S201, a searcher inputs a search phrase to the document filtering apparatus 100 via the information input/output unit 101.

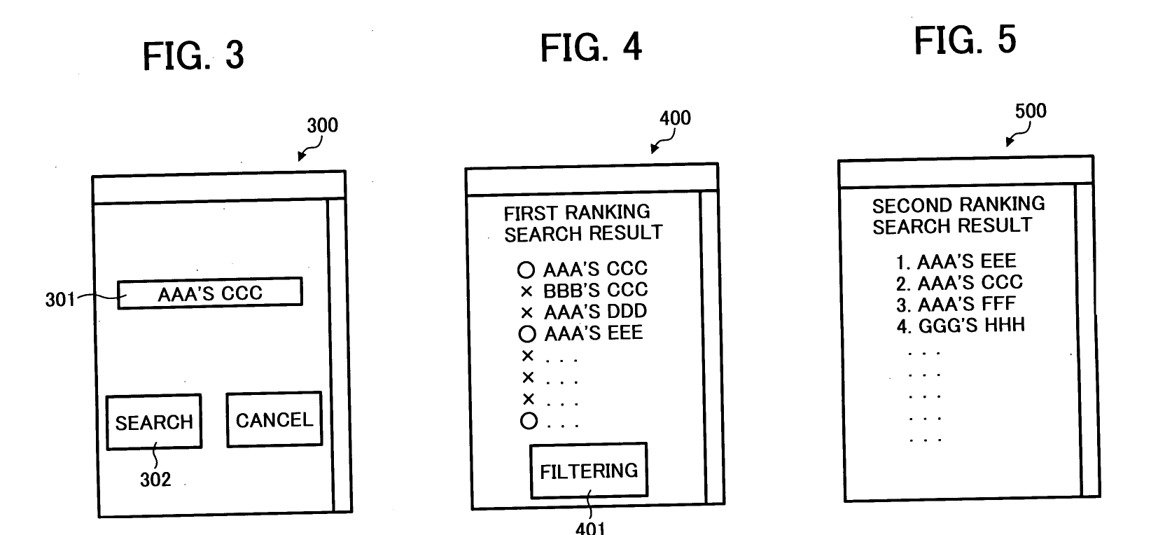

Specifically, as illustrated in FIG. 3, the searcher inputs the search phrase in a search word input field 301 of an image frame 300, displayed on a display unit (not shown) of the information input/output unit 101. By clicking a search button 302 in the image frame 300, the document filtering apparatus 100 starts a first ranking search using the search phrase.

In Step S202, the search word extraction unit 102 extracts a search word from the search phrase.

In Step S203, the document ranking search unit 103 performs a first ranking search in the database 110 for documents having the search word extracted by the search word extraction unit 102 to obtain a first ranking search result. The first ranking search result in Step S203 is transmitted to the information input/output unit 101. In the ranking search, searched documents are ranked according to relevance to a searcher's intention of each of the documents.

In Step S204, the information input/output unit 101 displays the first ranking search result received from the document ranking search unit 103 on its display unit (not shown).

As illustrated in FIG. 4, the searcher reviews the first ranking search result, and designates documents included in the first ranking search result as a matched document when a document matches to a searcher's-intention and an unmatched document when a document does not match to a searcher's intention via the information input/output unit 101.

Specifically, the searcher put indication to documents included in the first ranking search result to distinguish matched documents and unmatched documents. For example, the searcher put an indication of “circle” for a matched document, and an indication of “cross” for an unmatched document as illustrated in an image frame 400 in FIG. 4. Then, click a filtering button 401 in the image frame 400. By clicking the filtering button 401, following Steps S205 to S212 are performed automatically.

In Step S205, based on such indicated information, the learning data generation unit 104 prepares learning data classifying documents matching to the searcher's intention as matched documents, and documents not matching to the searcher's intention as unmatched documents. The learning data include at least a part of the matched documents and unmatched documents which have been searched, but a search precision is improved by including as large as amount of document data.

In Step S206, the classifying parameter generation unit 105 automatically generates a classifying parameter based on the learning data prepared in the learning data generation unit 104.

Hereinafter, an exemplary method of generating a classifying parameter using an algorism such as a linear SVM (support vector machine), a Fisher discriminant, a binary independence model of Bayes will be explained.

As for the classifying parameters, for example, a vector “w,” and a scalar “b” included in a following vector equation are used.
f(x)=sgn(w·x+b) (1)
wherein the “x” is a feature vector of learning data, “w·x” is an inner product of the vector “w” and the vector “x,” and the vector “w” and “b” are parameters determined by learning.

A sgn(x) becomes “+1” when an argument “x” (i.e., scalar value) is larger than 0, and becomes “−1” when an argument “x” (i.e., scalar value) is 0 or less.

The vector “w” is defined as follow.
w=ΣV(wi)×wi
wherein the “i” takes a value from 1 through n, which is the number of search words.

The values of “V(wi),” “wi,” and “b” are determined by learning. Specifically, the values of “V(wi),” “wi,” and “b” are determined such that the values of f(x) becomes “+1” (i.e., matched document) when the value of learning data is larger than 0, and becomes “−1” (i.e., unmatched document) when the value of learning data is 0 or less.

The “V(wi)” is used as a weight (i.e., feature of word) of the word “wi,” and the “b” is a threshold value. The “wi” corresponds to each word.

In Step S207, using a word corresponding to the classifying parameter generated in the classifying parameter generation unit 105 as a search word, the document ranking search unit 103 performs a second ranking search to search documents having such search word from the database 110.

In Step S207, the second ranking search is performed using word corresponding to the classifying parameter. In this case, used number of words is “n”, wherein the “n” is a natural number.

A document “di” obtained by the second ranking search is provided with a document score as follow. For example, when using a classifying parameter “w” of the equation of
f(x)=sgn(w·x+b),
a document score of
score(di)=w·xi (2)
is provided to the document “di,” wherein the “xi” is a feature vector of the document “di.”

The classifying unit 106 evaluates documents obtained by the second ranking search using the classifying parameter, and extracts matched documents. Specifically, following steps are performed.

In Step S208, each document obtained in Step S207 is designated as document “di” having a score (i.e., score(di)) calculated by using the classifying parameter.

In Step S209, it is determined whether the score(di) exceeds the threshold value “b” obtained in Step S206.

When the score(di) exceeds the threshold value “b,” that means “YES” in Step S209. In this case, a relationship of “score(di)+b>0” is established by using the classifying parameter “b” of f(x)=sgn(w·x+b), for example.

Then, in Step S210, the document “di” is designated as a matched document, and go to Step S211.

When the score(di) does not exceed the threshold value “b”, that means “NO” in Step S209. In this case, go to Step S211.

In Step S211, it is checked whether all documents obtained by the second ranking search are processed through steps S208 to S210.

When it is confirmed that all documents are processed through steps S208 to S210, that means “YES” in Step S211, and go to Step S212.

When it is detected that at least one of the documents is not processed through steps S208 to S210, that means “NO” in Step S211. In this case, go back to Step S208, and continue the above-mentioned Steps S208 to S211.

When it is confirmed that all documents obtained by the second ranking search are processed through steps S208 to S210, in Step S211, that means “YES” in Step S211. Then, the classifying unit 106 transmits results obtained in Step S210 to the information input/output unit 101.

In Step S212, the information input/output unit 101 displays the results received from the classifying unit 106 as a second ranking search result (i.e., overview of matched documents), which is illustrated as an image frame 500 in FIG. 5, for example, on the display unit (not shown) of the information input/output unit 101. In Step S212, the second ranking search result can be sorted in the order of document scores.

Hereinafter, an exemplary document searching by a method of document filtering of the present invention will be explained.

For example, a searcher inputs a search phrase of “AAA's CCC” via the information input/output unit 101.

Assume that a first ranking search using the above-mentioned search phrase obtains a following first ranking search result which includes following four documents as top 1 to 4 documents.
1. AAA's CCC
2. BBB's CCC
3. AAA's DDD
4. AAA's EEE

The searcher designates documents as a matched document with an indication of “circle (i.e., 0),” and as an unmatched document with an indication of “cross (i.e., x),” for example.
o AAA's CCC
x BBB's CCC
x AAA's DDD
o AAA's EEE

Based on such indicated information, the classifying parameter generation unit automatically generates classifying parameters, and assume that a following group of words “AAA, BBB, CCC, DDD” are obtained, wherein an weight of AAA is 0.5, BBB is −0.6, CCC is 0.3, DDD is −0.2, and EEE is 0.1, and threshold value “b” is −0.4.

Then, a second ranking search is performed using the above-mentioned words “AAA, BBB, CCC, and DDD” as search words, and the above-mentioned score value is calculated for each document obtained by the second ranking search. For example, assume that documents “d1, d2, and d3” having following scores are obtained by the second ranking search.

The document “d1” has words “BBB and CCC.” Thus, the score(d1) is calculated as −0.6+0.3=−0.3, and score(d1)+b=−0.3−0.4=−0.7<0 is established. Therefore, the document “d1” is not output as a matched document.

The document “d2” has words “AAA and DDD.” Thus the score(d2) is calculated as 0.5−0.2=0.3, and score(d2)+b=0.3−0.4=−0.1<0 is established. Therefore, the document “d2” is not output as a matched document.

The document “d3” has words “AAA and EEE.” Thus the score(d3) is calculated as 0.5+0.1=0.6, and score(d3)+b =0.6−0.4=0.2>0 is established. Therefore, the document “d3” is output as a matched document.

Accordingly, the method and apparatus for document filtering of the present invention can extract the matched documents from documents obtained by the second ranking search.

As described above, the method and apparatus for document filtering of the present invention can prepare learning data from a first ranking search result, automatically generate classifying parameters from the learning data used for a second ranking search, automatically evaluate unknown document to distinguish a matched document or unmatched document using the classifying parameters, and automatically extract the matched document. Accordingly, the document matching to the searcher's intention can be searched efficiently in a short period of time.

The method and apparatus for document filtering according to an exemplary embodiment of the present invention can be performed by executing a program stored in a personal computer, a work station or the like. The program may be stored in a recording medium readable by a computer, such as a hard disk, a flexible disk, a CD-ROM, a MO (magneto-optical storage), a DVD (digital versatile disc) or the like, and executed by a computer. Furthermore, the program may be communicated via a network such as the Internet.

As described above, the method and apparatus for document filtering, and the program for document filtering of the present invention are useful for searching documents, and especially for searching documents from a huge amount of document data.

The invention may be conveniently implemented using a conventional general purpose digital computer programmed according to the teaching of the present specification, as will be apparent to those skilled in art in the computer art. Appropriate software coding can readily be prepared by skilled programmers based on the teaching of the present disclosure, as will be apparent to those skilled in art in the software art. The present invention may also be implemented by the preparation of the application specific integrated circuits or by interconnecting an appropriate network of conventional component circuits, as will be apparent to those skilled in the art.

Numerous additional modifications and variations are possible in light of the above teachings. It is therefore to be understood that within the scope of the appended claims, the disclosure of the present patent specification may be practiced otherwise than as specifically described herein. For example, elements and/or features of different illustrative embodiments may be combined with each other and/or substitutional for each other within the scope of this disclosure and appended claims.

1. A document filtering apparatus, comprising:
an information input/output unit configured to input phrasal information, and to output search result information;
a search word extraction unit configured to extract a search word from the phrasal information;
a document ranking search unit configured to perform a first ranking search and a second ranking search, wherein the first ranking search is used to search a database for a document having the search word, and output the document as a first ranking search result;
a learning data generation unit configured to prepare learning data reflecting a searcher's intention based on the first ranking search result;
a classifying parameter generation unit configured to generate a classifying parameter from the learning data prepared by the learning data generation unit, the classifying parameter being used by the second ranking search of the document ranking search unit to find a document from the database having a word corresponding to the classifying parameter; and
a classifying unit configured to extract a document matching to the searcher's intention, and output the document as a second ranking search result.

2. The document filtering apparatus according to claim 1, wherein the learning data generation unit prepares the learning data using at least a part of the first ranking search result.

3. The document filtering apparatus according to claim 1, wherein the classifying parameter generation unit generates the classifying parameter using a predetermined algorithm.

4. The document filtering apparatus according to claim 3, wherein the predetermined algorithm includes at least one of a linear support vector machine, a Fisher discriminant, and a binary independence model of Bayes.

5. The document filtering apparatus according to claim 1, wherein the classifying unit evaluates documents obtained by the second ranking search, designates the documents as a matched document when a predetermined condition is satisfied and as an unmatched document when the predetermined condition is not satisfied, extracts the matched document, and transmits the matched document to the information input/output unit.

6. The document filtering apparatus according to claim 5, wherein the predetermined condition is calculated using the classifying parameter.

7. The document filtering apparatus according to claim 5, wherein the classifying unit sorts the second ranking search result with a predetermined criterion.

8. The document filtering apparatus according to claim 7, wherein the predetermined criterion includes a score calculation using the classifying parameter.

9. A document filtering apparatus, comprising:
inputting and outputting means for inputting phrasal information, and outputting search result information;
extracting means for extracting a search word from the phrasal information;
document ranking searching means for performing a first ranking search and a second ranking search, wherein the first ranking search searches a database for document having the search word, and outputs the document as a first ranking search result;
preparing means for preparing learning data reflecting a searcher's intention based on the first ranking search result;
generating means for generating a classifying parameter from the learning data prepared by the preparing means, the classifying parameter being used by the second ranking search of the document ranking searching means to find a document from the database having a word corresponding to the classifying parameter; and
classifying means for extracting a document matching to the searcher's intention, and outputting the document as a second ranking search result.

10. The document filtering apparatus according to claim 9, wherein the preparing means prepares the learning data using at least a part of the first ranking search result.

11. The document filtering apparatus according to claim 9, wherein the generating means generates the classifying parameter using a predetermine algorithm.

12. The document filtering apparatus according to claim 11, wherein the predetermined algorithm includes at least one of a linear support vector machine, a Fisher discriminant, and a binary independence model of Bayes.

13. The document filtering apparatus according to claim 9, wherein the classifying means evaluates documents obtained by the second ranking search, designates the documents as a matched document when a predetermined condition is satisfied and as an unmatched document when the predetermined condition is not satisfied, extracts the matched document, and transmits the matched document to the inputting and outputting

14. The document filtering apparatus according to claim 13, wherein the predetermined condition is calculated using the classifying parameter.

15. The document filtering apparatus according to claim 13, wherein the classifying means sorts the second ranking search result with a predetermined criterion.

16. The document filtering apparatus according to claim 15, wherein the predetermined criterion includes a score calculation using the classifying parameter.

17. A method of document filtering, comprising the steps of:
inputting phrasal information;
extracting a search word from the phrasal information;
searching a database for a document having the search word, and outputting the document as a first ranking search result;
preparing learning data reflecting a searcher's intention based on the first ranking search result;
generating a classifying parameter from the learning data prepared by the preparing step;
finding a document from the database, the document containing a word corresponding to the classifying parameter;
picking-up a document matching to the searcher's intention;
outputting the document as a second ranking search result; and
displaying the second ranking search result.

18. The method of document filtering according to claim 17, wherein the preparing step prepares the learning data using at least a part of the first ranking search result.

19. The method of document filtering according to claim 17, wherein the generating step generates the classifying parameter using a predetermined algorithm.

20. The method of document filtering according to claim 19, wherein the predetermined algorithm includes at least one of a linear support vector machine, a Fisher discriminant, and a binary independence model of Bayes.

21. The method of document filtering according to claim 17, wherein the classifying step evaluates documents obtained by the second ranking search, designates the documents as a matched document when a predetermined condition is satisfied and as an unmatched document when the predetermined condition is not satisfied, extracts the matched document, and transmits the matched document to the displaying step.

22. The method of document filtering according to claim 21, wherein the predetermined condition is calculated using the classifying parameter.

23. The method of document filtering according to claim 21, wherein the classifying step sorts the second ranking search result with a predetermined criterion.

24. The method of document filtering according to claim 23, wherein the predetermined criterion includes a score calculation using the classifying parameter.

25. A program product for document filtering configured to cause a computer to perform a method of document filtering, the method of document filtering comprising the steps of:
inputting phrasal information;
extracting a search word from the phrasal information;
searching a database for a document having the search word, and outputting the document as a first ranking search result;
preparing learning data reflecting a searcher's intention based on the first ranking search result;
generating a classifying parameter from the learning data prepared by the preparing step;
finding a document from the database, the document containing a word corresponding to the classifying parameter;
picking-up a document matching to the searcher's intention;
outputting the document as a second ranking search result; and
displaying the second ranking search result.

26. A computer readable medium storing a program product for document filtering configured to cause a computer to perform a method of document filtering, the method of document filtering comprising the steps of:
inputting phrasal information;
extracting a search word from the phrasal information;
searching a database for a document having the search word, and outputting the document as a first ranking search result;
preparing learning data reflecting a searcher's intention based on the first ranking search result;
generating a classifying parameter from the learning data prepared by the preparing step;
finding a document from the database, the document containing a word corresponding to the classifying parameter;
picking-up a document matching to the searcher's intention;
outputting the document as a second ranking search result; and
displaying the second ranking research result.
